(19) United States
(12) Patent Application Publication
(10) Pub. No.: US 2016/0358727 A1
(43) Pub. Date: Dec. 8, 2016

(54) ELECTRONIC COMPONENT WITH MOVEABLE PART

(71) Applicant: TOKYO COSMOS ELECTRIC CO., LTD., Kanagawa (JP)

(72) Inventor: Masaru MIYAGI, Kanagawa (JP)

(21) Appl. No.: 15/039,698

(22) PCT Filed: Dec. 11, 2013
(86) PCT No.: PCT/JP2013/007275

§ 371 Date: May 26, 2016

(51) Int. Cl. H01H 19/02; H01H 19/06

(52) U.S. Cl. CPC H01H 19/025; H01H 19/06

(57) ABSTRACT

The purpose of the present invention is to effectively carry out waterproofing, while avoiding cramping an internal space to the extent it is possible to do so. The component is provided with: a light source (16a); a moveable part (11) having a first window (11a); a circuit board (16); and a housing (12, 13, 14, 15) in which is formed an opening (12b) through which the surface of the moving part (11) protrudes. The housing (12, 13, 14, 15), in combination with the moveable part (11), has dividing walls (12d, 13a) for dividing the internal space of the housing (12, 13, 14, 15) into a first space and a second space. The dividing walls (12d, 13a) support the moveable part (11), and the light source (16a) illuminates the first window (11a) through a portion (12d) of the dividing walls (12d, 13a), which are formed by transmissive members.

### TECHNICAL FIELD

The present invention relates to an electronic component equipped with a movable part (hereinafter, referred to as “movable-part-equipped electronic component”), the movable part being disposed so as to protrude from an opening portion of a housing, including a lighting window formed therein and being movable by operation of an operator.

### BACKGROUND ART

Electronic components each provided with a rotary movable part have been popular. Examples of such an electronic component include an electronic component provided with a dial for adjusting the temperature of a seat heater of an automobile and an electronic component provided with a dial for adjusting the exposure of a digital camera.

In the electronic components described above, for the purpose of enabling a rotary operation of the movable part using a finger, an opening portion is formed in the housing that houses therein the movable part, and the movable part is disposed so as to protrude from the opening portion.

In this case, a gap is formed between the housing and movable part. For this reason, when liquid spills over the electronic component, the liquid enters inside the electronic component from the gap and may break the electronic component.

In this respect, Patent Literature (hereinafter, referred to as “PTL”) 1 discloses a drip-proof structure for an electronic component for preventing the entry of liquid by providing a ring-shaped protrusion on the side of the movable part and a ring-shaped recess on the side of the housing.

Moreover, in addition to the electronic component disclosed in PTL 1, an electronic component in which the movable part partially lights up has been disclosed. For example, PTLs 2 and 3 disclose a drop-proof structure for a rotary electronic component in which an outline character formed in the surface of the rotary movable part lights up.

The drip-proof structure disclosed in PTL 2 prevents liquid from entering inside by disposing a rubber-like drip-proof plate at the gap between the opening portion of the housing and the movable part to seal the gap.

In addition, in the drip-proof structure disclosed in PTL 3, an electrically-operable component is formed as a separate unit from a mechanically-operable component to which the movable part is attached, thereby preventing liquid from entering an electrically functional part of the electrically-operable component.

Furthermore, these rotary electronic components are internally provided with a light guide part composed of a translucent synthetic resin and having a tip portion extending to a lower portion of the movable part. The light emitted from a light-emitting element is guided to the tip portion by the light guide part. The outline character formed in the surface of the movable part is illuminated by the light emitted from the tip portion.

### CITATION LIST

### Patent Literature

PTL 1

Japanese Patent Application Laid-Open No. 2008-123904

PTL 2

Japanese Patent Application Laid-Open No. 2011-134573

PTL 3

Japanese Patent Application Laid-Open No. 2010-009937

### SUMMARY OF INVENTION

### Technical Problem

With the related art disclosed in PTL 2, however, the rubber-like drip-proof plate used for preventing the entry of liquid and the light guide plate used for illuminating the outline character are provided separately, so that the internal space of the rotary electronic component becomes so small that it becomes difficult to dispose another component.

Likewise, in the related art disclosed in PTL 3, the waterproof case used for supporting the movable part and the light guide plate used for illuminating the outline character are provided separately, so that the internal space of the rotary electronic component becomes so small that it becomes difficult to dispose another component.

For this reason, how waterproofing is effectively performed while a reduction in the internal space is avoided as much as possible in the movable-part-equipped electronic component having a lighting movable part has become an important challenge.

The present invention has been made in view of the aforementioned problem and aims to implement a movable-part-equipped electronic component capable of effectively performing waterproofing while avoiding a reduction in the internal space as much as possible.

### Solution to Problem

A movable-part-equipped electronic component according to the present invention includes: a light source; a movable part including a window formed therein, the window allowing light from the light source to pass therethrough; a circuit board which outputs a signal in accordance with motion of the movable part; and a housing including an opening portion formed therein, the housing being configured to house the light source, the movable part, and the circuit board, the opening portion being an opening through which a surface of the movable part protrudes, in which the housing includes a separation wall when combined with the movable part, the separation wall separating an internal space of the housing into a first space and a second space and movably supporting the movable part, the movable part is combined with the separation wall in a direction from the first space, while the light source and the circuit board are disposed in the second space, and the separation wall is partially formed of a transparent member that allows light from the light source to pass therethrough, and the light source illuminates the window via the transparent member.

### Advantageous Effects of Invention

According to the present invention, a movable-part-equipped electronic component capable of effectively performing waterproofing while avoiding a reduction in the internal space as much as possible can be implemented.

### BRIEF DESCRIPTION OF DRAWINGS

FIG. 1 is a perspective view illustrating an exemplary configuration of a movable-part-equipped electronic component according to Embodiment 1 of the present invention;

FIG. 2 is a diagram illustrating an exploded view illustrating the exemplary configuration of the movable-part-equipped electronic component according to Embodiment 1 of the present invention;

FIG. 3 is a cross-sectional view illustrating a first exemplary configuration of the movable-part-equipped electronic component illustrated in FIGS. 1 and 2;

FIG. 4 is a cross-sectional view illustrating a second exemplary configuration of the movable-part-equipped electronic component;

FIG. 5 is a cross-sectional view illustrating a third exemplary configuration of the movable-part-equipped electronic component;

FIG. 6 is a diagram illustrating the brightness of a first window in the movable-part-equipped electronic component illustrated in FIG. 5;

FIG. 7 is a diagram illustrating the brightness of a first window in the movable-part-equipped electronic component illustrated in FIG. 4;

FIG. 8 is a diagram illustrating the brightness of a first window in the movable-part-equipped electronic component illustrated in FIG. 3; and

FIG. 9 is a cross-sectional view illustrating an exemplary configuration of a movable-part-equipped electronic component according to Embodiment 2 of the present invention.

### DESCRIPTION OF EMBODIMENTS

Hereinafter, a description will be given of embodiments of the present invention with reference to the drawings.

### Embodiment 1

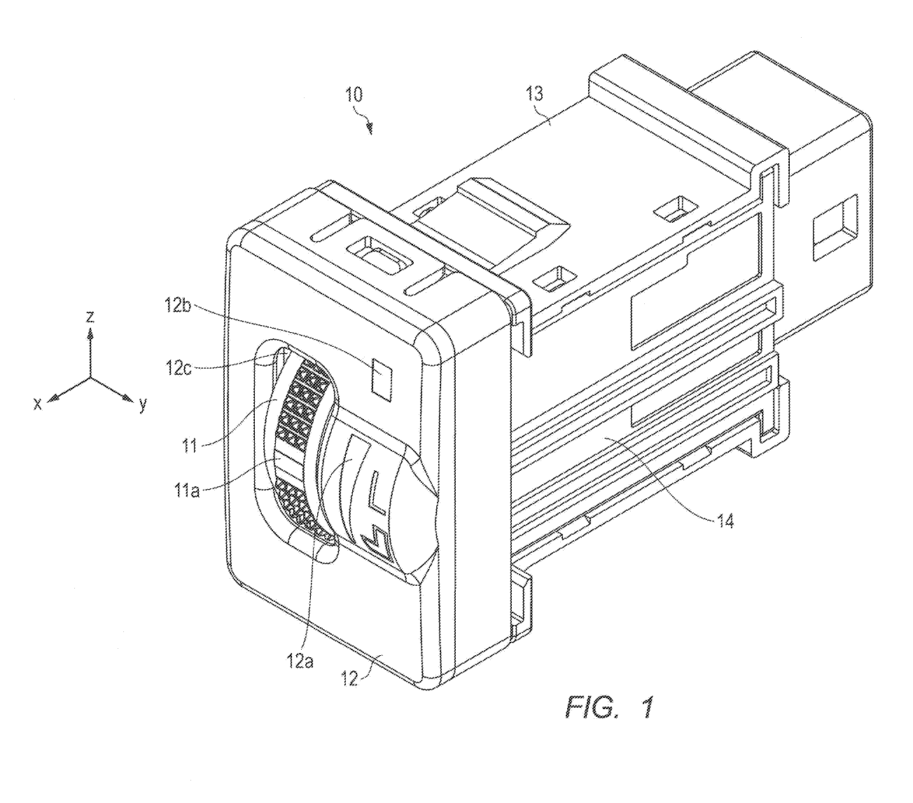

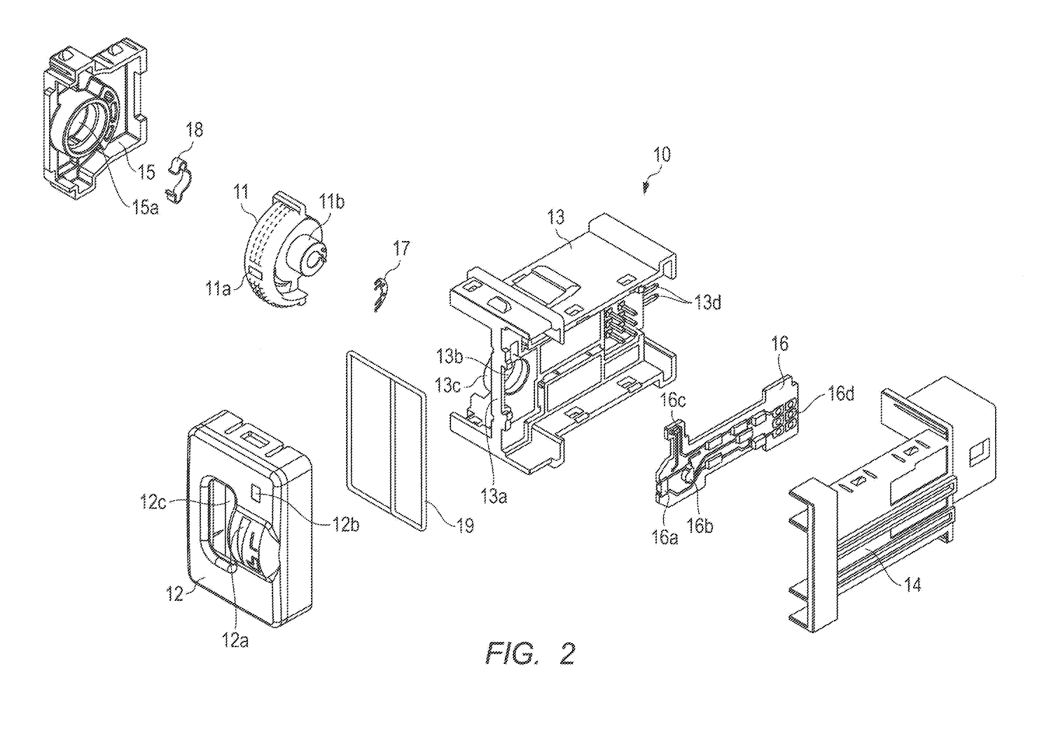

FIG. 1 is a perspective view illustrating an exemplary configuration of movable-part-equipped electronic component 10 according to Embodiment 1 of the present invention. FIG. 2 is an exploded view illustrating the exemplary configuration of movable-part-equipped electronic component 10 according to Embodiment 1 of the present invention.

Hereinafter, a description will be given of a case where movable-part-equipped electronic component 10 is an electronic component provided with a dial for adjusting the temperature of a seat heater of an automobile. However, movable-part-equipped electronic component 10 is not limited to this case, and may be another electronic component having a movable part.

As illustrated in FIGS. 1 and 2, movable-part-equipped electronic component 10 includes movable part 11, bezel 12, first housing member 13, second housing member 14, third housing member 15, circuit board 16, slider 17, click spring 18, and waterproof rubber 19.

Movable part 11 is a dial in which first window 11a for allowing the light from light source 16a (to be described hereinafter) to pass therethrough is formed. In addition, rotary shaft 11b having a cylindrical shape is formed in movable part 11. Rotary shaft 11b is rotatably fitted to opening portion 13b of first housing member 13.

Slider 17 is attached to rotary shaft 11b. Slider 17 is a member forming a part of a variable resistor. A resistive element (not illustrated) is formed on circuit board 16 to be described hereinafter, and the variable resistor is composed of slider 17 and the resistive element.

More specifically, slider 17 slides on the resistive element in accordance with the rotation of movable part 11 to change the output voltage of the variable resistor. The temperature of the seat heater is thus controlled in accordance with this output voltage.

Movable part 11 is formed of a transparent acrylonitrile butadiene styrene (ABS) resin, for example. The portion of the outer-side surface of movable part 11, which protrudes from opening portion 12c of bezel 12 except for first window 11a, is painted in black in order for the light from light source 16a to pass through only first window 11a.

Bezel 12 is a housing member forming a part of the housing for housing light sources 16a to 16c, movable part 11, and circuit board 16, for example. In bezel 12, the following parts are formed: second window 12a for allowing the light from light source 16b to pass therethrough; third window 12b for allowing the light from light source 16c (to be described hereinafter) to pass therethrough; and opening portion 12c.

Bezel 12 is formed of a transparent ABS resin, for example. In order for the light beams from light source 16b and light source 16c to pass through only second window 12a and third window 12b, respectively, the outer-side surface portion of bezel 12 except for second window 12a and third window 12b is painted in black. In addition, movable part 11 is disposed at opening portion 12c so as to protrude from opening portion 12c. In this manner, movable part 11 becomes rotatable using a finger.

In movable-part-equipped electronic component 10, first, second, and third windows 11a, 12a, and 12b are so assigned light sources 16a, 16b, and 16c, respectively, that first, second, and third windows 11a, 12a, and 12b can light up brightly.

First housing member 13 is a housing member forming a part of the housing. First housing member 13 includes wall surface 13a, opening portion 13b, bearing wall 13c, and terminals 13d.

Wall surface 13a separates the internal space of the housing of movable-part-equipped electronic component 10 into a first space and a second space when combined with movable part 11, and support wall 12d (to be described hereinafter) provided to bezel 12.

More specifically, wall surface 13a and support wall 12d form a separation wall that separates the internal space of the housing into the first space and the second space when combined with movable part 11.

The housing is formed by combining bezel 12, first housing member 13, second housing member 14, and third housing member 15. The first space indicates the space side where the body portion of movable-part 11 exists, and the second space indicates the space side where light sources 16a to 16c and circuit board 16 are disposed.

In opening portion 13b, rotary shaft 11b of movable-part 11 is rotatably inserted into opening portion 13b as described above. Bearing wall 13c is a cylindrical wall surface and is formed so as to protrude from the body portion of wall surface 13a into the first space. Bearing wall 13c comes into surface contact with rotary shaft 11b and rotatably supports rotary shaft 11b from outside.

Terminal 13d is bonded to electrode 16d provided at circuit board 16. The signal in accordance with the rotation angle of movable-part 11 is outputted from terminal 13d.

Second housing member 14 and third housing member 15 are each a housing member forming a part of the housing. In third housing member 15, opening portion 15a is formed. The rotary shaft of movable part 11 (not illustrated) (i.e., rotary shaft provided on a side opposite to the side where rotary shaft 11b is provided) is rotatably inserted into opening portion 15a.

Circuit board 16 supplies light sources 16a to 16c provided on circuit board 16 with power and outputs the signal in accordance with the motion of movable part 11 from electrode 16d. More specifically, circuit board 16 outputs the voltage signal of the variable resistor in accordance with the motion of movable part 11 to outside from electrode 16d via terminal 13d. Light sources 16a to 16c are each a light emitting diode (LED) light source.

Slider 17 is a member forming a part of the variable resistor and slides on the resistive element in accordance with the rotation of movable part 11 and changes the output voltage of the variable resistor as described above.

Click spring 18 is attached to movable part 11 and rotates together with movable part 11. Click spring 18 has at least one protrusion (two protrusions in the example of FIG. 2). Meanwhile, a protrusion is formed in an inner side of opening portion 15a of third housing member 15.

In this manner, the operator of movable part 11 can have a click feeling of movable part 11 when the protrusion of click spring 18 passes over the protrusion formed at opening portion 15a. For example, when the protrusion of opening portion 15a is formed to cause a click feeling at the rotation angle corresponding to switch off, the operator can easily confirm whether the switch off operation is successfully performed.

Waterproof rubber 19 is a sealing member disposed between bezel 12 and first housing member 13. When bezel 12 is combined with first housing member 13, waterproof rubber 19 is pressed against first housing member 13. Thus, the entry of liquid between bezel 12 and first housing member 13 can be suppressed.

The separation wall mentioned above is partially formed of a transparent member that allows the light from light source 16a to pass therethrough. Light source 16a illuminates first window 11a in the first space via the transparent member. This point will be described hereinafter in detail.

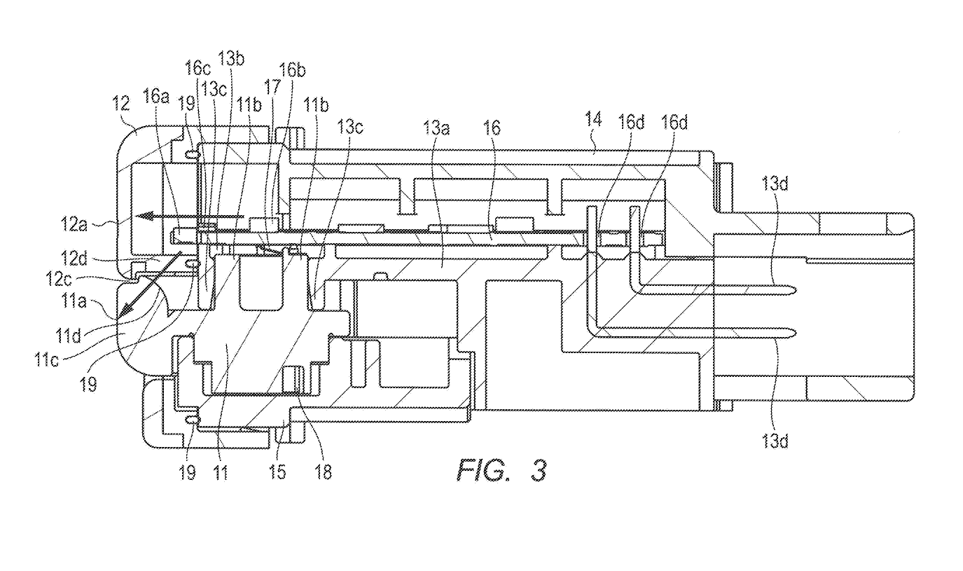

FIG. 3 is a cross-sectional view illustrating a first exemplary configuration of movable-part-equipped electronic component 10 illustrated in FIGS. 1 and 2. The cross-section illustrated in FIG. 3 is a cross-section obtained by cutting movable-part-equipped electronic component 10 in FIG. 1 along the x-y plane passing through the center of first window 11a.

As illustrated in FIG. 3, there is no obstacle that interrupts the progression of light between light source 16b and second window 12a, so that the light emitted from light source 16b illuminates second window 12a. Accordingly, second window 12a lights up.

Likewise, although not illustrated in FIG. 3, third window 12b illustrated in FIG. 2 is illuminated by the light emitted from light source 16c. Accordingly, third window 12b lights up.

Meanwhile, supporting wall 12d that supports bezel 12 and wall surface 11c having an arc-like outer periphery exist between light source 16a and first window 11a. Supporting wall 12d is a part of bezel 12 and wall surface 11c is a part of movable part 11.

As described above, bezel 12 is formed of a transparent ABS resin, so that supporting wall 12d allows the light emitted from light source 16a to pass therethrough. In addition, movable part 11 is also formed of a transparent ABS resin, so that wall surface 11c allows the light emitted from light source 16a to pass therethrough. For this reason, the light emitted from light source 16a can illuminate first window 11a.

The second space where circuit board 16 exists is separated by supporting wall 12d, movable part 11, and wall surface 13a from the first space where the body portion of movable part 11 exists. Thus, even when the liquid enters the first space, it is possible to prevent the liquid from entering the second space.

As described above, movable-part-equipped electronic component 10 according to Embodiment 1 includes the separation wall that separates the internal space of the housing into the first space and the second space. This separation wall is formed when wall surface 13a and supporting wall 12d are combined with movable part 11. Supporting wall 12d is formed of a transparent member that allows the light emitted from light source 16a to pass therethrough, so that first window 11a is illuminated by the light that has passed through supporting wall 12d.

More specifically, supporting wall 12d is to prevent liquid from entering the second space where circuit board 16 exits from the first space where movable part 11 exits, and also to light up first window 11a provided at movable part 11.

For this reason, a transparent member for guiding the light to first window 11a does not have to be provided independently from the separation wall. Accordingly, waterproofing can be effectively performed while a reduction in the internal space of movable-part-equipped electronic component 10 is avoided as much as possible.

Bearing wall 13c having a cylindrical shape and rotatably supporting rotary shaft 11b of movable part 11 from outside is formed at wall surface 13a so as to protrude from the body portion of wall surface 13a into the first space where movable part 11 exists.

As described above, the protrusion of bearing wall 13c into the first space makes the moving distance needed for fluid to enter the second space longer, so that it is made possible to surely prevent the liquid from entering the second space where circuit board 16 exists from the gap between bearing wall 13c and rotary shaft 11b.

In addition, supporting wall 12d of bezel 12 may be disposed on a side surface of bearing wall 13c protruding from wall surface 13a. For this reason, the position where supporting wall 12d is disposed can be flexibly determined.

For example, when the position where supporting wall 12d is disposed is moved to the side of the first space, the second space can be larger, and it is thus made possible to further increase the degree of freedom in design such as where to dispose light source 16a.

In the example of FIG. 3, first window 11a is provided at the outer side of wall surface 11c in movable part 11, and lens 11d is formed at the inner side of wall surface 11c. Lens 11d collects the light that has passed through supporting wall 12d to first window 11a. Thus, it is possible to light up first window 11a more brightly.

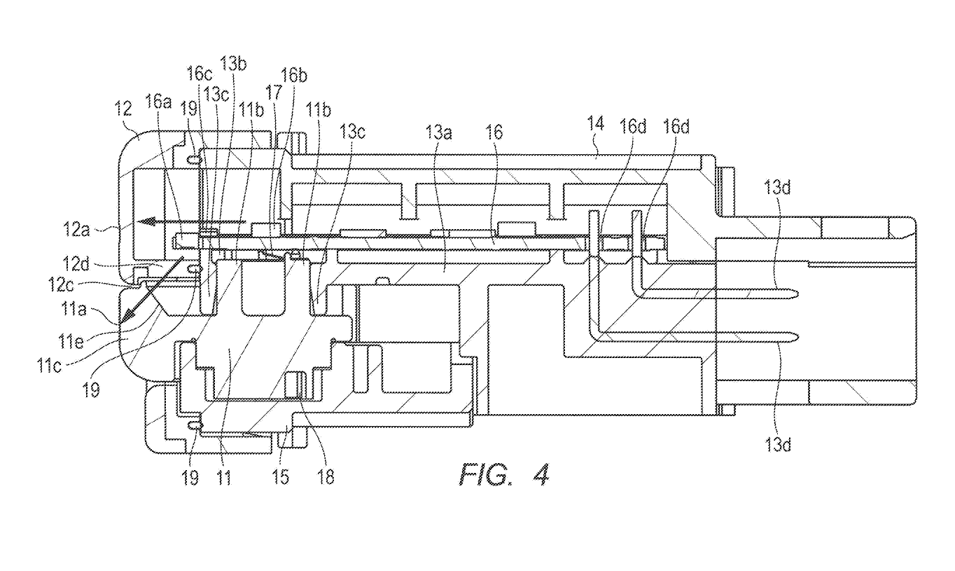

Note that, it is possible to form an inclined plane instead of forming lens 11d at the inner side of wall surface 11c. FIG. 4 is a cross-sectional view illustrating a second exemplary configuration of movable-part-equipped electronic component 10. The cross-section illustrated in FIG. 4 is a cross-section obtained by cutting movable-part-equipped electronic component 10 illustrated in FIG. 1 along the x-y plane passing through the center of first window 11a.

In the configuration of FIG. 4 as well, the protrusion of bearing wall 13c into the first space makes it possible to surely prevent the liquid from entering the second space where circuit board 16 exists from the gap between bearing wall 13c and rotary shaft 11b.

In addition, supporting wall 12d of bezel 12 may be disposed on a side surface of bearing wall 13c protruding from wall surface 13a. Thus, the position where supporting wall 12d is disposed can be flexibly determined.

Moreover, in the example of FIG. 4, first window 11a is provided at the outer side of wall surface 11c in movable part 11, and inclined plane 11e is formed at the inner side of wall surface 11c. As will be described hereinafter, inclined plane 11e is also capable of collecting the light that has passed through supporting wall 12d to first window 11a. Thus, it is possible to light up first window 11a brightly.

Moreover, the inner side of wall surface 11c may be vertical plane 11f. FIG. 5 is a cross-sectional view illustrating a third exemplary configuration of movable-part-equipped electronic component 10. The cross-section illustrated in FIG. 5 is a cross-section obtained by cutting movable-part-equipped electronic component 10 illustrated in FIG. 1 along the x-y plane passing through the center of first window 11a.

In the configuration of FIG. 5, the protrusion of bearing wall 13c into the first space makes it possible to surely prevent the liquid from entering the second space where circuit board 16 exists from the gap between bearing wall 13c and rotary shaft 11b.

In addition, supporting wall 12d of bezel 12 may be disposed on a side surface of bearing wall 13c protruding from wall surface 13a. For this reason, the position where supporting wall 12d is disposed can be flexibly determined.

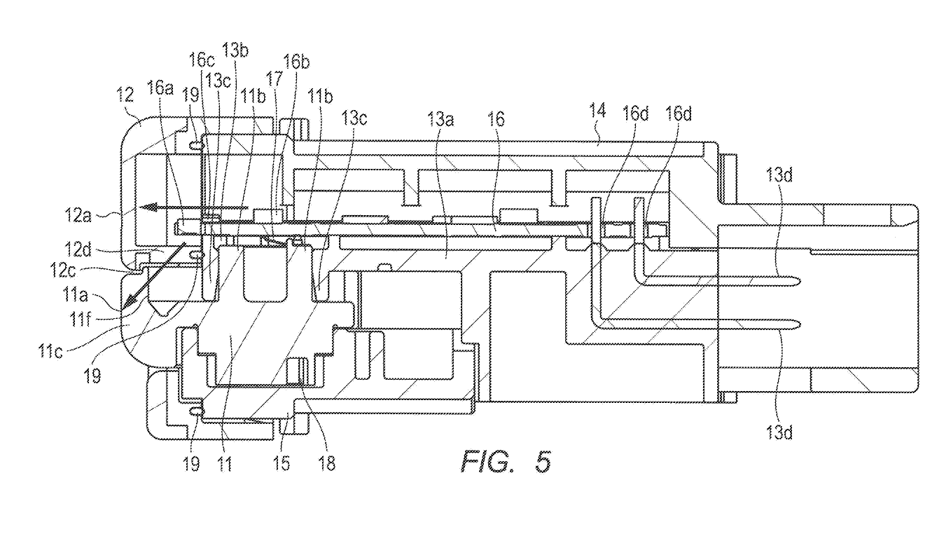

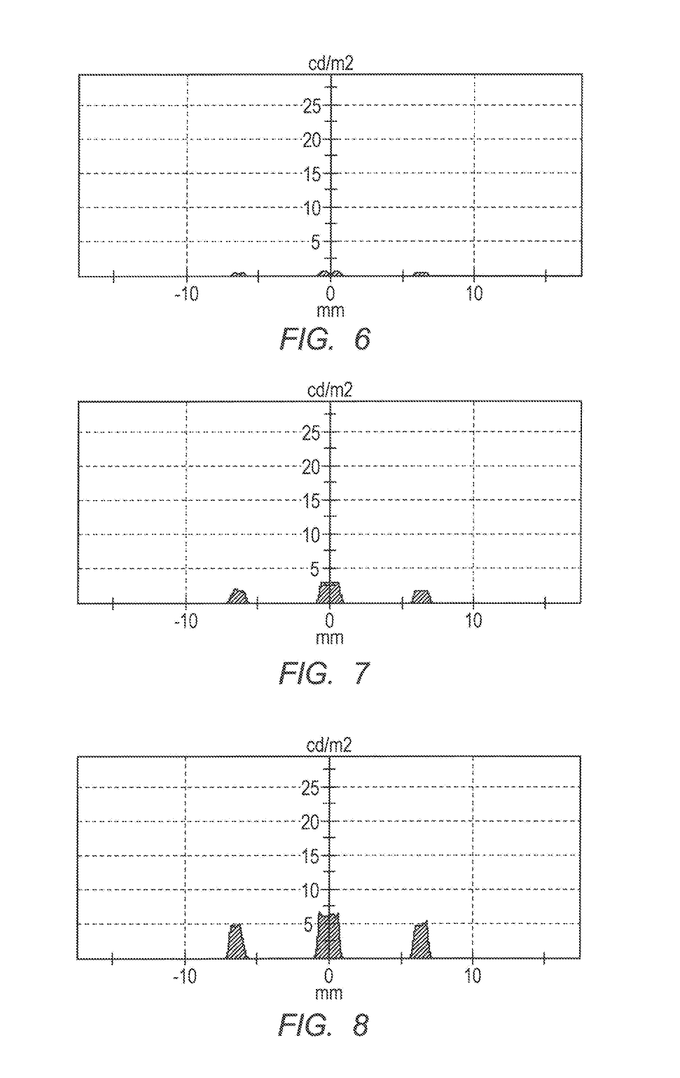

Next, a description will be given of the brightness of first window 11a in each of the configurations of movable-part-equipped electronic component 10 illustrated in FIGS. 3 to 5. FIG. 6 is a diagram illustrating the brightness of first window 11a in movable-part-equipped electronic component 10 illustrated in FIG. 5. FIG. 7 is a diagram illustrating the brightness of first window 1 la in movable-part-equipped electronic component 10 illustrated in FIG. 4. FIG. 8 is a diagram illustrating the brightness of first window 11a in movable-part-equipped electronic component 10 illustrated in FIG. 3.

FIGS. 6 to 8 indicate the brightness value of a case where first window 11a is positioned at the center of opening portion 12c of bezel 12 (value near 0 mm in the horizontal axis), the brightness value of a case where movable part 11 rotates by a predetermined angle from the center of opening portion 12c (value near 7 mm in the horizontal axis), and the brightness value of a case where movable part 11 rotates in a reverse direction by a predetermined angle from the center of opening portion 12c (value near −7 mm in the horizontal axis).

As illustrated in FIGS. 6 and 7, the brightness in first window 11a of movable-part-equipped electronic component 10 illustrated in FIG. 4 is approximately three times the brightness in first window 11a of movable-part-equipped electronic component 10 illustrated in FIG. 5.

In addition, as illustrated in FIGS. 6 and 8, the brightness in first window 11a of movable-part-equipped electronic component 10 illustrated in FIG. 3 is approximately six times the brightness in first window 11a of movable-part-equipped electronic component 10 illustrated in FIG. 5.

As described above, it can be seen that the brightness when first window 11a lights up is the largest in movable-part-equipped electronic component 10 in which lens 11d is formed at the inner side of wall surface 11c, illustrated in FIG. 3, and movable-part-equipped electronic component 10 in which inclined plane 11e is formed at the inner side of wall surface 11c, illustrated in FIG. 4 has the second largest brightness.

Accordingly, movable-part-equipped electronic component 10 can be manufactured by selecting an appropriate configuration from among the configurations illustrated in FIGS. 3 to 5 in accordance with the brightness required when first window 11 a lights up.

### Embodiment 2

In Embodiment 1, light source 16a illuminates first window 11a and light source 16b illuminates second window 12a, but light source 16a may be configured to illuminate both first window 11a and second window 12a to reduce the number of light sources.

Thus, a movable-part-equipped electronic component that lights up first window 11a formed in movable part 11 and second window 12a formed in bezel 12 can be implemented while the number of parts is reduced. Hereinafter, a description will be given of movable-part-equipped electronic component 10 according to Embodiment 2 in detail.

As in movable-part-equipped electronic component 10 described in Embodiment 1, movable-part-equipped electronic component 10 according to Embodiment 2 includes movable part 11, bezel 12, first housing member 13, second housing member 14, third housing member 15, circuit board 16, slider 17, click spring 18, and waterproof rubber 19, as illustrated in FIG. 1.

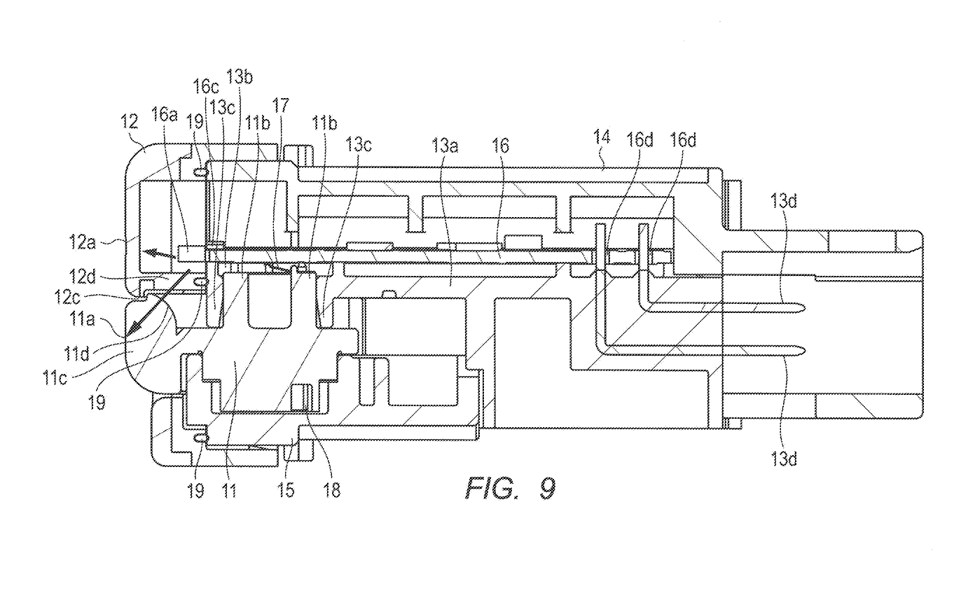

FIG. 9 is a cross-sectional view illustrating an exemplary configuration of movable-part-equipped electronic component 10 according Embodiment 2 of the present invention. The cross-section illustrated in FIG. 9 is a cross-section obtained by cutting movable-part-equipped electronic component 10 illustrated in FIG. 1 along the x-y plane passing through the center of first window 11a.

Note that, in FIG. 9, the members identical to the members described in FIG. 3 are assigned the same reference numerals, and the detailed description thereof will be omitted, hereinafter.

Movable-part-equipped electronic components 10 illustrated in FIGS. 9 and 3 are different from each other in that movable-part-equipped electronic component 10 illustrated in FIG. 9 includes no light source 16b, but light source 16a illuminates both first window 11a and second window 12a.

Movable part 11 is formed of a transparent member (e.g., transparent ABS resin) that allows the light from light source 16a to pass therethrough. The portion of the outer-side surface portion of movable part 11 protruding from opening portion 12c of bezel 12 except for first window 11a is painted in black in order for the light from light source 16a to pass through only first window 11a.

In addition, bezel 12 is also formed of a transparent member (e.g., transparent ABS resin) that allows the light from light sources 16a and 16c to pass therethrough. The outer-side surface portion of bezel 12 other than second window 12a and third window 12b is painted in black in order to allow the light beams from light sources 16a and 16c to pass through second and third windows 12a and 12b, respectively.

In movable-part-equipped electronic component 10, there is no obstacle that interrupts the progression of light between light source 16a and second window 12a, so that the light emitted from light source 16a illuminates second window 12a. Accordingly, second window 12a lights up.

Meanwhile, supporting wall 12d that supports bezel 12 and wall surface 11c having an arc-like outer periphery exist between light source 16a and first window 11a. Supporting wall 12d is a part of bezel 12 and wall surface 11c is a part of movable part 11.

Bezel 12 is formed of a transparent member such as an ABS resin that allows the light from light source 16a to pass therethrough, so that supporting wall 12d allows the light emitted from light source 16a to pass therethrough. In addition, movable part 11 is also formed of a transparent member such as an ABS resin that allows the light from light source 16a to pass therethrough, so that wall surface 11c allows the light emitted from light source 16a to pass therethrough.

For this reason, the light emitted from light source 16a can illuminate first window 11a. Thus, it is possible to light up both second window 12a and first window 11a while the number of light sources is reduced.

In addition, the second space where circuit board 16 exists is separated from the first space where the body portion of movable part 11 exists by supporting wall 12d, movable part 11, and wall surface 13a. Thus, even when the liquid enters the first space, it is possible to prevent the liquid from entering the second space.

As described above, in movable-part-equipped electronic component 10 according to Embodiment 2, the liquid can be prevented from entering from the gap between bezel 12 and movable part 11, and first window 11a provided in movable part 11 and second window 12a provided in bezel 12 can light up, respectively, while the number of light sources 16a is reduced.

Moreover, as in Embodiment 1, supporting wall 12d in movable-part-equipped electronic component 10 according to Embodiment 2 is to prevent the liquid from entering the second space where circuit board 16 exists from the first space where movable part 11 exists and also to light up first window 11a provided in movable part 11.

For this reason, the transparent member for guiding the light to first window 11a does not have to be provided independently from the separation wall. Thus, waterproofing can be effectively performed while a reduction in the internal space of movable-part-equipped electronic component 10 is avoided.

In wall surface 13a, bearing wall 13c having a cylindrical shape and rotatably supporting rotary shaft 11b of movable part 11 from outside is formed so as to protrude from the body portion of wall surface 13a into the first space where movable part 11 exists.

As described above, the protrusion of bearing wall 13c into the first space makes the moving distance needed for the fluid to enter the second space longer, the liquid can be surely prevented from entering the second space where circuit board 16 exists from the gap between bearing wall 13c and rotary shaft 11b.

In addition, supporting wall 12d of bezel 12 may be disposed on a side surface of bearing wall 13c protruding from wall surface 13a. For this reason, the position where supporting wall 12d is disposed can be flexibly determined

For example, when the position where supporting wall 12d is disposed is moved to the side of the first space, the second space can be larger, and it is thus made possible to further increase the degree of freedom in design such as where to dispose light source 16a.

In the example of FIG. 9, first window 11a is provided at the outer side of wall surface 11c in movable part 11, and lens 11d is formed at the inner side of wall surface 11c. Lens 11d collects the light that has passed through supporting wall 12d to first window 11a. Thus, it is possible to light up first window 11a more brightly.

Note that, it is possible to form inclined plane 11e at the inner side of wall surface 11c as illustrated in FIG. 4 instead of forming lens 11d at the inner side of wall surface 11c or it is also possible to form vertical plane 11f as illustrated in FIG. 5.

Although a description has been given of the case where movable part 11 is a rotary dial in Embodiments 1 and 2, movable part 11 is not limited to this case. For example, movable part 11 may be a seesaw switch or push button switch or the like.

Even when movable part 11 is one of these switches mentioned above, the transparent member for guiding the light to first window 11a does not have to be provided independently from the separation wall, so that waterproofing can be effectively performed while a reduction in the internal space of movable-part-equipped electronic component 10 is avoided as much as possible.

### INDUSTRIAL APPLICABILITY

The movable-part-equipped electronic component according to the present invention is suitable for use as a movable-part-equipped electronic component required to effectively perform waterproofing while avoiding a reduction in the internal space as much as possible.

### REFERENCE SIGNS LIST

10 Movable-part-equipped electronic component
11 Movable part
11a First window
11b Rotary shaft
11c Wall surface
11d Lens
11e Inclined plane
11f Vertical plane
12 Bezel
12a Second window
12b Third window
12c Opening portion
12d Supporting wall
13 First housing member
13a Wall surface
13b Opening portion
13c Bearing wall
13d Terminal
14 Second housing member
15 Third housing member
15a Opening portion
16 Circuit board
16a to 16c Light source
16d Electrode
17 Slider
18 Click spring
19 Waterproof rubber

1. A movable-part-equipped electronic component comprising:
a light source;
a movable part including a window formed therein, the window allowing light from the light source to pass therethrough;
a circuit board which outputs a signal in accordance with motion of the movable part; and
a housing including an opening portion formed therein, the housing being configured to house the light source, the movable part, and the circuit board, the opening portion being an opening through which a surface of the movable part protrudes, wherein
the housing includes a separation wall when combined with the movable part, the separation wall separating an internal space of the housing into a first space and a second space and movably supporting the movable part,
the movable part is combined with the separation wall in a direction from the first space, while the light source and the circuit board are disposed in the second space, and
the separation wall is partially formed of a transparent member that allows light from the light source to pass therethrough, and the light source illuminates the window via the transparent member.

2. The movable-part-equipped electronic component according to claim 1, wherein the movable part is a rotary member including a wall surface having an arc-like outer periphery.

3. The movable-part-equipped electronic component according to claim 2, wherein the window is disposed at an outer side of the wall surface, and a lens is formed at an inner side of the wall surface.

4. The movable-part-equipped electronic component according to claim 2, wherein the window is disposed at an outer side of the wall surface, and an inclined plane is formed at an inner side of the wall surface.

5. The movable-part-equipped electronic component according to claim 2, wherein a cylindrical rotary shaft is formed in the movable part, and a cylindrical bearing wall rotatably supporting the rotary shaft from outside is formed at the separation wall so as to protrude from a body portion of the separation wall into the first space, and wherein a side surface of the bearing wall protruding from the body portion of the separation wall supports the separation wall formed of the transparent member.

6. The movable-part-equipped electronic component according to claim 1, wherein another light source, which is different from the light source, is provided in the second space, and a window that allows light from the other light source to pass therethrough is formed in the housing.

7. The movable-part-equipped electronic component according to claim 1, wherein another window that allows light from the light source to pass therethrough is formed in the housing, and wherein the light source illuminates the other window formed in the housing in the second space while illuminating, via the transparent member, the window formed in the movable part in the first space.

8. The movable-part-equipped electronic component according to claim 1, wherein the housing is composed of a combination of at least two members, and wherein a sealing member is included between the two members.
